(19) United States
(12) Patent Application Publication
(10) Pub. No.: US 2017/0218607 A1
(43) Pub. Date: Aug. 3, 2017

(54) PROGRAMMABLE WATER SHUTOFF VALVE

(71) Applicant: Arthur Woods, Jackson, TX (US)

(72) Inventor: Arthur Woods, Jackson, TX (US)

(21) Appl. No.: 15/008,987

(22) Filed: Jan. 28, 2016

(51) Int. Cl. E03C 1/05; F16K 31/02

(52) U.S. Cl. CPC E03C 1/057; F16K 31/02

(57) ABSTRACT

Provided is an apparatus for regulating water flow to a structure. The apparatus generally comprises an electrically operated valve, sensors for temperature and flow-rate, and a module for communication. The remotely controllable shutoff valve contains a battery backup to provide power in case of an electrical outage. The apparatus is installed downstream from a structure's main water valve, shutting off the water supply according to a schedule that can be programmed into a controller, or smart-home hub.

### STATEMENT RE: FEDERALLY SPONSORED RESEARCH/DEVELOPMENT

(Not Applicable)

### FIELD OF THE INVENTION

The present invention relates generally to plumbing systems. More particularly, the invention relates to a convenient water supply shutoff apparatus incorporated in the water supply line.

### BACKGROUND OF THE INVENTION

A problem of great concern is that of water damage to a structure. The damage done by water can come in many forms, such as burst pipes and flooding from a leaking fixture or appliance. Water damage is a concern for many homeowners. Many times, however, the water supply to a structure cannot be shut off before significant damage occurs.

The cost of a water leak can range from anywhere to a higher water bill to a catastrophic cost. Water can damage electronics, carpet, flooring, furniture, and especially irreplaceable items such as keepsakes, photos and financial records, not to mention the mental anguish associated with the destruction of such valuables. Water can also cause significant structural damage to a home depending upon the location of the leak.

Water damage oftentimes occurs when the ambient temperature drops to near the freezing point of water, which causes water in a pipe to expand and rupture the pipe. A burst pipe then allows water to flow, without abatement, into areas of a structure that are not meant for contact with water. Were this to occur in a residential dwelling, any inhabitants would likely be forced to leave the home depending upon the location of the pipe. In addition to the stress of having to leave one's home, there is the cost associated with repairing the damage caused by the water.

This problem is exacerbated when a leak occurs in an unoccupied structure. A burst pipe can cause considerable damage in a very short amount of time; the amount of damage that could be caused by a burst pipe could be exponentially worse if the burst pipe goes unnoticed. Furthermore, the mere presence of water in a structure's pipes can be enough to cause damage to plumbing and plumbing fixtures even if the water supply is shut off. Accordingly, there is a need for a system that can drain the standing water already within the pipes of a structure.

A homeowner may mitigate the causes of water damage by manually turning off the main supply valve before leaving his own. Without a constant flow of water, the structure is protected from costly water damage, which can also cause a residence to be inhabitable. This is a cumbersome task to perform, and a significant portion of homeowners are not even aware of the location of their main water valve. Furthermore, these valves are often hidden in shrubbery, and are exposed to the elements. Turning off the water supply using an old valve may be problematic due to its exposure to the elements, and many of these valves become stuck over time. Further, in the time it takes one to locate and turn off the water supply, a considerable amount of damage may have already occurred.

The water supply to a structure may also need to be turned off in the event of a natural disaster. Natural disasters are typically accompanied by various negative externalities, such as interruptions of the electrical power grid. In such an event, it is not only advantageous to have a water shutoff system that is located in an easier to reach location than primary shutoff valves, but to also have a shutoff valve that contains a battery backup. With such a system, one can turn off the water supply during a natural disaster without having to leave the safety of the structure, and also without electrical power.

There are ecological concerns to be taken into account, as well. Aging structures often have issues with leaking pipes and fixtures. With fresh, potable water becoming a scarcer and more expensive resource, owners of structures are looking for ways to save this precious resource. This can be accomplished by turning off the water supply to a structure according to a schedule. Scheduled shutoff of a structure's water supply negates the impact of both known and unknown water leaks.

What is needed in the art is an apparatus that allows a structure's water to be turned off remotely, during scheduled vacancies, or when flooding is detected.

Additionally, in the event of a power outage, the apparatus should be able to continue operation for a short period of time until power is restored.

It is an overriding object of the present invention to improve upon prior art by providing a system whereby the owner(s) of a structure may protect themselves from water leaks. It is another object of this invention to provide a system whereby the water supply to a structure can be shut off remotely, without having to locate a difficult to use manual shutoff valve. It is another object of this invention to assimilate into a system for web-enabled control of appliances. Finally, it is an object of the invention to provide a system that can save water by controlling the main water supply to a structure on a predefined schedule.

### BRIEF SUMMARY OF THE INVENTION

In accordance with the foregoing objects, the present invention generally comprises a remotely controllable shutoff valve and a control panel to activate and deactivate the shutoff valve. The shutoff valve is interposed a water line from a water main to the distribution system of the structure such that activating the shutoff valve prevents water from flowing into the pipes of the structure.

The primary object of the invention is to provide an apparatus that enables automatic shutoff of a structure's water supply in situations where manual shutoff would be difficult, tedious, and/or impractical to accomplish.

Another object of this invention is to provide a method of shutting off water supply to a structure during times when water supply is unnecessary.

Another object of the invention is to allow the water to be shut off automatically without user intervention, such as when temperatures drop to near freezing levels.

Another object of the invention is to take into account the amount of water flowing through the main water line, as well as the temperature of the water, and using this information to shut off the water supply accordingly.

Another object of the invention is to provide a system to drain any standing water in a structure's pipes by providing a drainage system that is automatically activated when there is danger of water freezing in the structure's pipes.

The present invention provides an apparatus allowing the system to turn off the water supply to the structure that has the apparatus installed. The water supply maybe turned on or off via the control panel with the keypad, without needing physical access to the shutoff valve. The system may also be programmed at the control panel to turn the water supply off in accordance with a number of triggers, such as: a predetermined schedule, the temperature of the water within the pipes, the amount of water flowing through the pipe, and/or the detection of water leaks within a structure. Within the body of the shutoff valve is a sensor to detect the amount of water flowing through the valve, as well as a sensor to determine the temperature of the water. The shutoff valve contains a means to transmit data remotely to a controller. The shutoff valve assembly also has a battery backup that will provide power in case electricity is not available from a wall outlet.

The water shutoff valve is interposed the main water valve and the water line into the structure. The valve is operated by an electrical controller, and is also manually operable. The shutoff valve can be located in a location that is more convenient to access than the primary shutoff valve.

In an increasingly connected world, it is important to have a system that will not be an isolated system. In one embodiment, the system will have wireless capabilities. Appliances such as HVAC systems, ovens, and refrigerators are capable of being controlled wirelessly via industry-standard protocols. Therefore, the wireless communication standard for communication between the control panel and shutoff valve can be any number of common standards, such as Bluetooth, Wi-Fi, Z-Wave or radio frequencies. The shutoff valve communicates directly with the control panel.

Each communications standards has its own strengths and drawbacks, and one familiar with the art can choose the most suitable standard. For example, Wi-Fi generally requires a Local Area Network to be created by a separate device, while Bluetooth does not require a separate network. As is known in the art, flood damage sensors that detect the presence of water can be installed throughout a structure. When these devices sense water, a signal is sent to the control panel, which can then shut off the water supply to a structure to mitigate the cost of water damage.

The control panel is located in an even more convenient to access location than the shutoff valve assembly, such as the laundry room or kitchen of a residence. The location is variable; all that is required is a power supply, such as an electrical outlet. The control panel also contains a battery backup to allow the system to continue operating during a power outage. The control panel provides an interface for the operator to set a schedule, should one be desired, for turning the water supply on or off. From the control panel the operator can also set the desired temperature that will trigger a shutoff of the water supply and drainage system.

The drainage system can be placed in any location between the programmable shutoff valve and the structure's pipes. Drainage systems generally require a method of injecting air into a water system to displace the water that is present in pipes, as is known in the art.

Control of the remotely controllable shutoff valve can also be accomplished with a smart-home hub. Homeowners are increasingly connected to the internet, be it with smartphones, tablets, or laptops. The ability to control a water shutoff system from any place with an internet connection is an attractive feature, and such products are beginning to gain a foothold in the marketplace. Smart-home hubs are manufactured by a variety of technology firms and appliance manufacturers. Hubs are able to control numerous internet-connected appliances including light bulbs, garage openers, ovens, and HVAC systems. With the aid of smart-home hubs, a homeowner can install a remotely controlled shutoff valve, and substitute the functions of the control panel with the software features of the smart-home hub.

### BRIEF DESCRIPTION OF THE DRAWINGS

The features and advantages of the various embodiments disclosed herein will be better understood with respect to the following description and drawings in which like numbers refer to like parts throughout and in which:

FIG. 1 is a diagram of the preferred embodiment of the programmable shutoff valve system as implemented in a residential structure.

FIG. 2 is a functional block diagram of the preferred embodiment of the controller.

FIG. 3 is a drawing of the preferred embodiment of the remotely controllable shutoff valve.

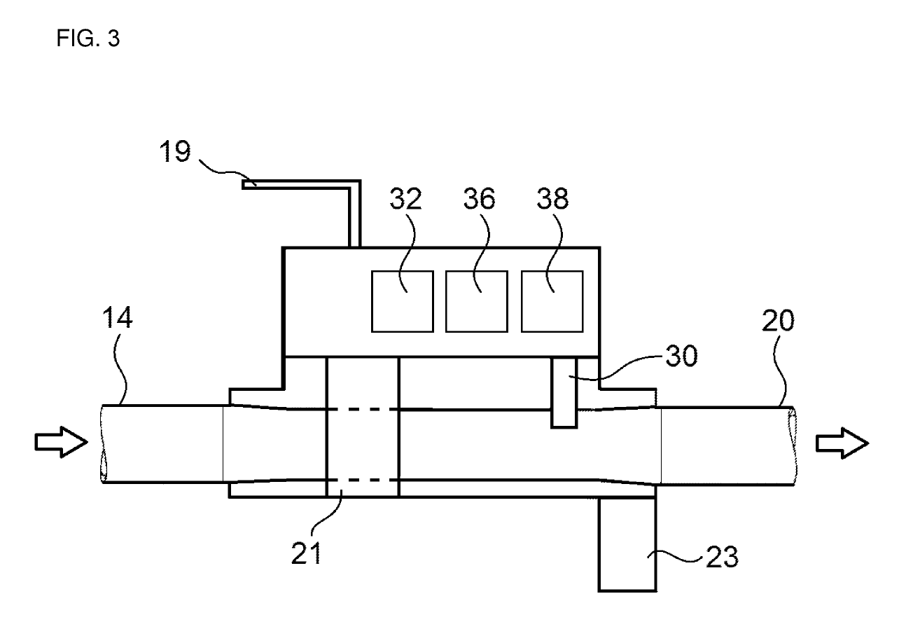

FIG. 4 is another embodiment of the programmable shutoff valve that does not require a controller.

### DETAILED DESCRIPTION OF THE PREFERRED EMBODIMENT

The detailed description that follows is intended to describe the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by a variety of different embodiments and that they are also intended to be encompassed within the scope of the invention.

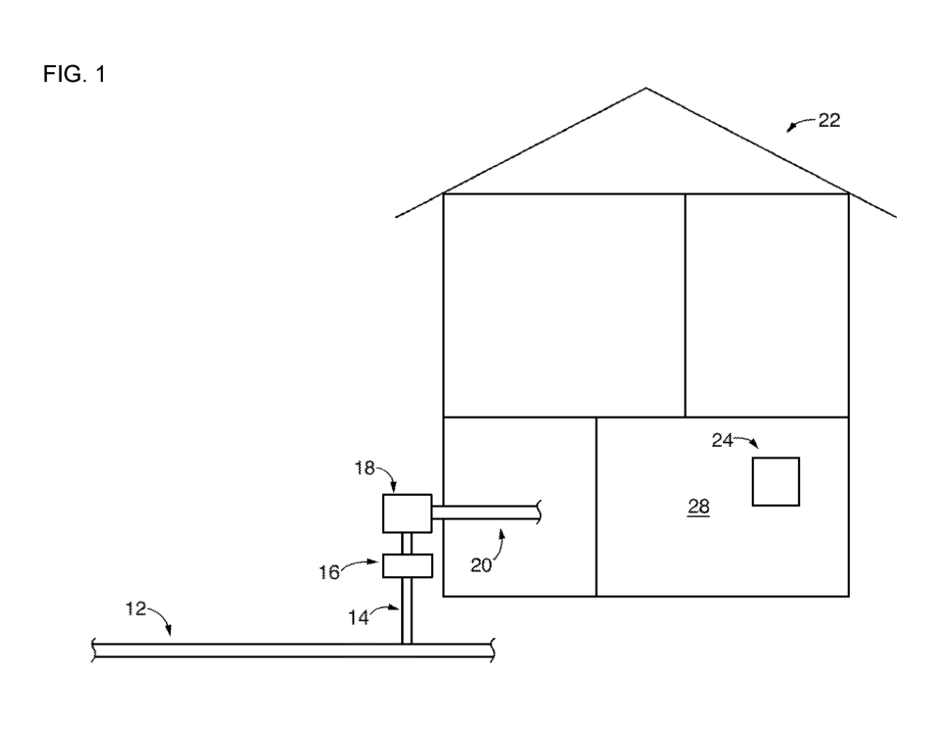

Referring now to FIG.1, the programmable water shutoff system of the present invention is shown to generally comprise a remotely controllable shutoff valve 18 and a controller 24. The remotely controllable shutoff valve 18 is interposed a main water line 12 and main shut off valve 16 and the residential water supply 20 to a residential structure 22. In the preferred embodiment of the present invention, the remotely controllable shutoff valve 18 is located downstream of a junction 34 that is used for irrigation 32, allowing the remotely controllable shutoff valve 18 to shutoff water supply to the residential structure 22 while allowing any irrigation to continue uninterrupted.

In one embodiment, the remotely controllable shutoff valve 18 contains an electrically actuated valve 21, an ambient temperature sensor 32, a means for sensing the flow-rate of water 30 from the main supply line 14, a means for manual operation of the valve 19, a means for drainage of water 23 that has already passed through the valve 21, a module for communication 36, and a battery backup 38.

The controller 24 is preferably located within the living quarters 28 of the residential structure 22. The controller 24 has a module for communication 40 with the remotely controllable shutoff valve 18, a microprocessor 42, a keypad 44 for user input of timing schedules and predetermined events for water shutoff, a display 48 to indicate current status of the shutoff valve 18, as well as other pertinent information, and a battery backup 46.

Typically, a schedule will be set with the controller 24; the schedule can be set, for example, to turn off the water supply when the structure will be empty, and to turn the supply back on when the structure will be occupied, or water flow is required. The remotely controllable shut off valve 18 will receive signals from the controller 24 in accordance with the schedule. There may be instances when it will be preferable to temporarily override the schedule, such as on a holiday, when a deviation from the schedule will be desired. A temporary override of the schedule will operate as follows: the state of the remotely controllable shutoff valve 18 will be changed by use of the controller 24. The state of the remotely controllable shutoff valve 18 will be changed from open to closed, or vice versa; the temporary override will cease when the next schedule timer event occurs, and the controller 24 will resume operation of the remotely controllable shutoff valve 18 in accordance with the schedule.

The remotely controllable shutoff valve 18 generally acts an open pipe, receiving water from the main supply 14, and allowing water to flow uninterrupted through to the structure's water supply 20. In normal operation, the temperature sensor 28 and flow-rate sensor 30 relate their respective information to the control panel 24 via the communications module 36. The controller display 48 displays the temperature and flow-rate values, as well as the status of the valve 21. While the battery backup 38 is available in the event of a power outage, one may also use the manual level 19 to close the electric valve 21 should manual operation be desirable; this also works as a fail-safe, allowing one to turn off the water supply to the structure 22 from a location that may not be as remote or hard to find as the main shutoff valve 16.

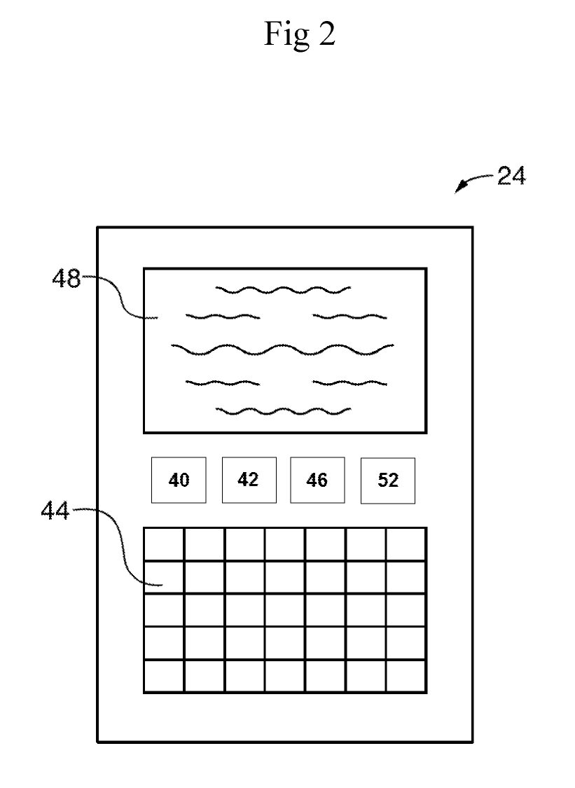

Now, referring to FIG. 2, operation of the system 10 is performed primarily via the control panel 24. The keypad 44 is used to activate and deactivate the electric valve 21. When the controller 24 sends the requisite signal to the remotely controllable shutoff valve 18, the electric valve 21 is actuated, turning off the water supply from the main supply line 14. The electric valve 21 may also be operated via the microprocessor 42 according to the user's parameters. The keypad 44 is also used for inputting parameters for autonomous control of the valve, such as a temperature threshold, and/or a flow-rate threshold. If the temperature falls below a user-defined value, the electrically controlled valve 21 can be closed; conversely, the electrically controlled valve 21 can be set to reopen when the temperature reading from the sensor 28 exceeds a user-defined value.

A flow-rate threshold value is utilized to activate the shutoff valve 18 when a value from the flow-rate sensor 30 is exceeded. With this method of control, the flow of too much water through the remotely controllable shutoff valve 18 could indicate that there water is proceeding unabated into the structure 22. Further autonomous control can be accomplished through the use of water sensors 26 that can be placed various rooms of the structure 22. These water sensors 26 are connected to the controller 24 via the communications module 40.

The keypad 44 is also used to define schedule for operation of the remotely controllable shutoff valve 18. The remotely controllable shutoff valve 18 would then operate in accordance with that schedule, unless an overriding event, such as a drop in temperature, triggers the controller 24 to change the state of the remotely controllable shutoff valve 18.

Operation of the controller 24 can also be accomplished remotely. The communication module of the 40 may connect to an internet-enabled gateway 42. While an internet connection is not required for the apparatus 10 to function, an internet connection would enable the operator to review information received by the controller 24 from the remotely controllable shutoff valve 18.

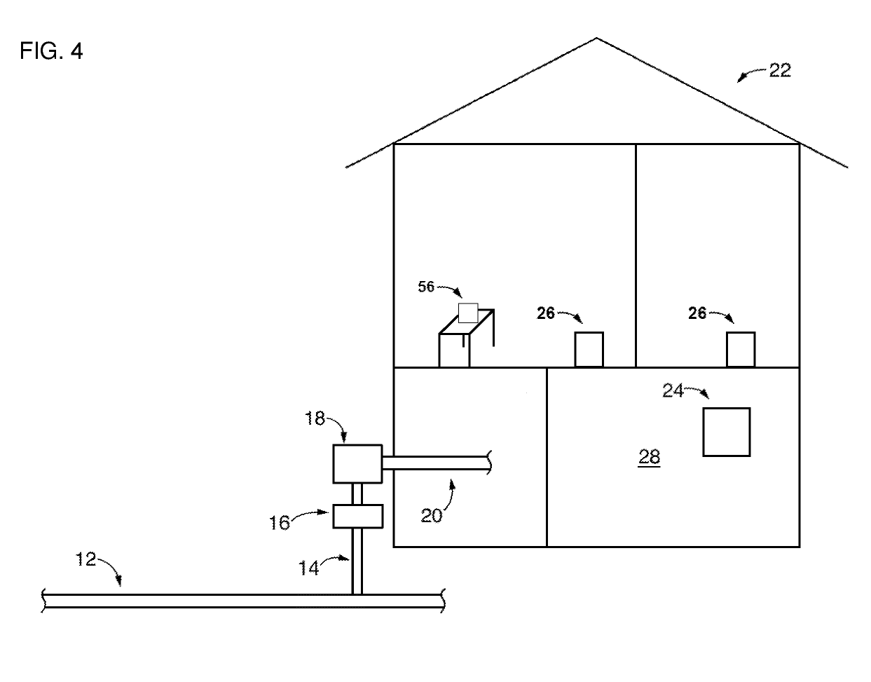

Now, referring to FIG. 4, the remotely controllable shutoff valve 18 is able to operate according to instructions from a smart-home hub 56. In this alternative embodiment, the operations of the controller 24 are assumed by the hub 56. The remotely controllable shutoff valve 18 communicates information from its various sensors 28, 30 via its communications module 36. Control of the electric valve 21 is accomplished by communications from the hub 56.

Now, referring to FIG. 4, the controller 24 can receive instructions from a smart-home hub 56. Thus, in this alternative embodiment, the operations of the remotely controllable shutoff valve 18 may be controlled by the smart-home hub 56 via the controller 24.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combinations described herein. Thus, the scope of the claims is not to be limited by the illustrated embodiments.

1. A remotely controllable water shutoff system usable in a structure with a main water supply and a primary manual water shutoff valve, said system comprising:
a secondary shutoff valve located along the structure's main water supply line, directly downstream from the structure's manual shutoff valve and prior to any branching off of the water supply;
an electrically operated controller to alter the state of the secondary shutoff valve between open and closed states;
a controller comprising:
a module for communication to said electronically operated controller to open or close the secondary shutoff valve;
a programmable timer schedule, said timer being adapted to actuate the module to communicate to the electronically operated controller to open or close the secondary shutoff valve;
means for inputting the timer schedule; and
a microprocessor to manage said timer function.

2. The remotely controllable water shutoff system of claim 1, wherein said water shutoff system comprises a means for drainage of water that has already passed through to the primary shutoff valve, said drain means installed at desired point of the main water line downstream from secondary shutoff valve operated via signals from the controller.

3. The remotely controllable water shutoff system of claim 1, wherein said schedule can be manually overridden.

4. The remotely controllable water shutoff system of claim 3, wherein said schedule is re-instated upon next scheduled event.

5. The remotely controllable water shutoff system of claim 1, wherein said secondary shutoff valve comprises a ball valve operable via electrical motor.

6. The remotely controllable water shutoff system of claim 1, wherein said shutoff valve comprises a gate valve operable via electrical motor.

7. The remotely controllable water shutoff system of claim 1, wherein said module for communication is wireless.

8. The remotely controllable water shutoff system of claim 1, wherein said controller is a panel.

9. The remotely controllable water shutoff system of claim 1, wherein said controller is a handheld electronic device.

10. The remotely controllable water shutoff system of claim 1, wherein said secondary shutoff valve contains a flow-rate sensor.

11. The remotely controllable water shutoff system of claim 1, wherein said system further comprises an ambient temperature sensor.

12. The remotely controllable water shutoff system of claim 2, wherein said system further comprises an ambient temperature sensor.

13. The remotely controllable water shutoff system of claim 12, wherein said system further comprises a means for operating drainage system in accordance with temperature sensor data.

14. The remotely controllable water shutoff system of claim 1, wherein said controller is a smart-home hub.

15. The remotely controllable water shutoff system of claim 1, wherein said system further comprises a means for temporary manual override of timer schedule.

16. The remotely controllable water shutoff system of claim 1, wherein said controller further comprises:
a means for receiving data from sensors located at various points throughout the structure, said sensors being able to detect the presence of water;
a means for receiving data from flow rate sensors located various points in pipes downstream from main shutoff valve.

17. A remotely controllable water shutoff system usable in a structure with a main water supply and a primary manual water shutoff valve, said system comprising:
a secondary shutoff valve located along the structure's main water supply line, directly downstream from the structure's manual shutoff valve and prior to any branching off of the water supply line;
an electrically operated controller to alter the state of the secondary shutoff valve between open and closed states;
a means for manual operation of the secondary shutoff valve;
a means for sensing flow rate through the secondary shutoff valve;
a module for sensing ambient temperature;
a module for communication of data regarding state of secondary shutoff valve, water temperature and flow rate;
a means for battery backup power for operation of secondary shutoff valve in the event of a power outage;
a control panel comprising:
a module for communication to said electrically operated controller to open or close the secondary shutoff valve;
a battery backup to allow operation of said second shutoff valve in the event of a power outage;
a programmable timer schedule, said timer being adapted to actuate the module to communicate to the electronically operated controller to open or close the secondary shutoff valve;
a means for temporary override of the timer;
a means for operating secondary shutoff valve in accordance with the information received from temperature and flow sensing means of remotely controllable shutoff system;
means for the input of the timer schedule; and
a microprocessor to manage said timer function.
